(19) United States
(12) Patent Application Publication
(10) Pub. No.: US 2008/0170083 A1
(43) Pub. Date: Jul. 17, 2008

(54) Efficient Memory Structure for Display System with Novel Subpixel Structures

(75) Inventors: Seok Jin Han, Cupertino, CA (US); Thomas Lloyd Credelle, Morgan Hill, CA (US); Moonhwan Im, Cupertino, CA (US)

Correspondence Address: CLAIRVOYANTE, INC., 874 GRAVENSTEIN HIGHWAY SOUTH, SUITE 14, SEBASTOPOL, CA, 95472, US

(73) Assignee: CLAIRVOYANTE, INC, Sebastopol, CA (US)

(21) Appl. No.: 11/910,645

(22) PCT Filed: Apr. 4, 2006
(86) PCT No.: PCT/US06/12768

§ 371 Date: Oct. 4, 2007

Related U.S. Application Data
(60) Provisional application No. 60/668,510, filed on Apr. 4, 2005.

(51) Int. Cl. G09G 5/02

(52) U.S. Cl. 345/589; 345/543

(57) ABSTRACT

Embodiments of efficient memory implementations for novel display system are herein disclosed. One embodiment comprises a display system comprising a display, said display comprising a plurality of logical pixels wherein said logical pixels further comprise a first number of center-subpixels and a memory, said memory storing said image data to be rendered by said display; wherein said memory is mapped such that said center-subpixels are stored in addressable memory cells.

### CROSS REFERENCE TO RELATED APPLICATIONS

This application claims the benefit of U.S. Provisional Application No. 60/668,578 entitled IMPROVED METHODS AND SYSTEMS FOR BY-PASSING SUBPIXEL RENDERING IN DISPLAY SYSTEMS, filed on Apr. 4, 2005 and is herein incorporated by reference in its entirety.

The following co-owned (and filed on same date) applications are related to the present application and are herein incorporated by reference: (1) U.S. patent application Ser. No. 60/668,511 entitled “SYSTEMS AND METHODS FOR IMPLEMENTING LOW-COST GAMUT MAPPING ALGORITHMS”; (2) U.S. patent application Ser. No. 60/668,512 entitled “SYSTEMS AND METHODS FOR IMPLEMENTING IMPROVED GAMUT MAPPING ALGORITHMS” and (3) U.S. patent application Ser. No. 60/668,578 entitled “IMPROVED METHODS AND SYSTEMS FOR BY-PASSING SUBPIXEL RENDERING IN DISPLAY SYSTEMS.

### TECHNICAL FIELD

The present application relates to systems and methods in various embodiments for providing efficient memory structures and methodologies for displays comprising novel subpixel layouts.

### BACKGROUND

In commonly owned United States patents and patent applications including: (1) U.S. Pat. No. 6,903,754 (“the '754 patent”) entitled “ARRANGEMENT OF COLOR PIXELS FOR FULL COLOR IMAGING DEVICES WITH SIMPLIFIED ADDRESSING;” (2) United States Patent Publication No. 2003/0128225 (“the '225 application”) having application Ser. No. 10/278,353 and entitled “IMPROVEMENTS TO COLOR FLAT PANEL DISPLAY SUB-PIXEL ARRANGEMENTS AND LAYOUTS FOR SUB-PIXEL RENDERING WITH INCREASED MODULATION TRANSFER FUNCTION RESPONSE,” filed Oct. 22, 2002; (3) United States Patent Publication No. 2003/0128179 (“the '179 application”) having application Ser. No. 10/278,352 and entitled “IMPROVEMENTS TO COLOR FLAT PANEL DISPLAY SUB-PIXEL ARRANGEMENTS AND LAYOUTS FOR SUB-PIXEL RENDERING WITH SPLIT BLUE SUB-PIXELS,” filed Oct. 22, 2002; (4) United States Patent Publication No. 2004/0051724 (“the '724 application”) having application Ser. No. 10/243,094 and entitled “IMPROVED FOUR COLOR ARRANGEMENTS AND EMITTERS FOR SUB-PIXEL RENDERING,” filed Sep. 13, 2002; (5) United States Patent Publication No. 2003/0117423 (“the '423 application”) having application Ser. No. 10/278,328 and entitled “IMPROVEMENTS TO COLOR FLAT PANEL DISPLAY SUB-PIXEL ARRANGEMENTS AND LAYOUTS WITH REDUCED BLUE LUMINANCE WELL VISIBILITY,” filed Oct. 22, 2002; (6) United States Patent Publication No. 2003/0090581 (“the '581 application”) having application Ser. No. 10/278,393 and entitled “COLOR DISPLAY HAVING HORIZONTAL SUB-PIXEL ARRANGEMENTS AND LAYOUTS,” filed Oct. 22, 2002; and (7) United States Patent Publication No. 2004/0080479 (“the '479 application”) having application Ser. No. 10/347,001 and entitled “IMPROVED SUB-PIXEL ARRANGEMENTS FOR STRIPED DISPLAYS AND METHODS AND SYSTEMS FOR SUB-PIXEL RENDERING SAME,” filed Jan. 16, 2003, novel sub-pixel arrangements are disclosed for improving the cost/performance curves for image display devices. Each of the aforementioned '225, '179, '724, '423, '581, and '479 published applications and U.S. Pat. No. 6,903,754 are hereby incorporated by reference herein in its entirety.

For certain subpixel repeating groups having an even number of subpixels in a horizontal direction, systems and techniques to affect improvements, e.g. proper dot inversion schemes and other improvements, are disclosed in the following commonly owned United States patent documents: (1) United States Patent Publication No. 2004/0246280 (“the '280 application”) having application Ser. No. 10/456,839 and entitled “IMAGE DEGRADATION CORRECTION IN NOVEL LIQUID CRYSTAL DISPLAYS”; (2) United States Patent Publication No. 2004/0246213 (“the '213 application”) (U.S. patent application Ser. No. 10/455,925) entitled “DISPLAY PANEL HAVING CROSSOVER CONNECTIONS EFFECTING DOT INVERSION”; (3) United States Patent Publication No. 2004/0246381 (“the '381 application”) having application Ser. No. 10/455,931 and entitled “SYSTEM AND METHOD OF PERFORMING DOT INVERSION WITH STANDARD DRIVERS AND BACKPLANE ON NOVEL DISPLAY PANEL LAYOUTS”; (4) United States Patent Publication No. 2004/0246278 (“the '278 application”) having application Ser. No. 10/455,927 and entitled “SYSTEM AND METHOD FOR COMPENSATING FOR VISUAL EFFECTS UPON PANELS HAVING FIXED PATTERN NOISE WITH REDUCED QUANTIZATION ERROR”; (5) United States Patent Publication No. 2004/0246279 (“the '279 application”) having application Ser. No. 10/456,806 entitled “DOT INVERSION ON NOVEL DISPLAY PANEL LAYOUTS WITH EXTRA DRIVERS”; (6) United States Patent Publication No. 2004/0246404 (“the '404 application”) having application Ser. No. 10/456,838 and entitled “LIQUID CRYSTAL DISPLAY BACKPLANE LAYOUTS AND ADDRESSING FOR NON-STANDARD SUBPIXEL ARRANGEMENTS”; (7) United States Patent Publication No. 2005/0083277 (“the '277 application”) having application Ser. No. 10/696,236 entitled “IMAGE DEGRADATION CORRECTION IN NOVEL LIQUID CRYSTAL DISPLAYS WITH SPLIT BLUE SUBPIXELS”, filed Oct. 28, 2003; and (8) United States Patent Publication No. 2005/0212741 (“the '741 application”) having application Ser. No. 10/807,604 and entitled “IMPROVED TRANSISTOR BACKPLANES FOR LIQUID CRYSTAL DISPLAYS COMPRISING DIFFERENT SIZED SUBPIXELS”, filed Mar. 23, 2004. Each of the aforementioned '280, '213, '381, '278, '404, '277 and '741 published applications are hereby incorporated by reference herein in its entirety.

These improvements are particularly pronounced when coupled with sub-pixel rendering (SPR) systems and methods further disclosed in the above-referenced U.S. patent documents and in commonly owned United States patents and patent applications: (1) United States Patent Publication No. 2003/0034992 (“the '992 application”) having application Ser. No. 10/051,612 and entitled “CONVERSION OF A SUB-PIXEL FORMAT DATA TO ANOTHER SUB-PIXEL DATA FORMAT,” filed Jan. 16, 2002; (2) United States Patent Publication No. 2003/0103058 (“the '058 application”) having application Ser. No. 10/150,355 entitled “METHODS AND SYSTEMS FOR SUB-PIXEL RENDERING WITH GAMMA ADJUSTMENT,” filed May 17, 2002; (3) United States Patent Publication No. 2003/0085906 (“the '906 application”) having application Ser. No. 10/215,843 and entitled “METHODS AND SYSTEMS FOR SUB-PIXEL RENDERING WITH ADAPTIVE FILTERING,” filed Aug. 8, 2002; (4) United States Publication No. 2004/0196302 (“the '302 application”) having application Ser. No. 10/379,767 and entitled “SYSTEMS AND METHODS FOR TEMPORAL SUB-PIXEL RENDERING OF IMAGE DATA” filed Mar. 4, 2003; (5) United States Patent Publication No. 2004/0174380 (“the '380 application”) having application Ser. No. 10/379,765 and entitled “SYSTEMS AND METHODS FOR MOTION ADAPTIVE FILTERING,” filed Mar. 4, 2003; (6) U.S. Pat. No. 6,917,368 (“the '368 Patent”) entitled “SUB-PIXEL RENDERING SYSTEM AND METHOD FOR IMPROVED DISPLAY VIEWING ANGLES”; and (7) United States Patent Publication No. 2004/0196297 (“the '297 application”) having application Ser. No. 10/409,413 and entitled “IMAGE DATA SET WITH EMBEDDED PRE-SUBPIXEL RENDERED IMAGE” filed Apr. 7, 2003. Each of the aforementioned '992, '058, '906, '302, 380 and '297 applications and the '368 patent are hereby incorporated by reference herein in its entirety.

Improvements in gamut conversion and mapping are disclosed in commonly owned United States Patents and co-pending United States patent applications: (1) U.S. Pat. No. 6,980,219 (“the '219 Patent”) entitled “HUE ANGLE CALCULATION SYSTEM AND METHODS”; (2) United States Patent Publication No. 2005/0083341 (“the '341 application”) having application Ser. No. 10/691,377 and entitled “METHOD AND APPARATUS FOR CONVERTING FROM SOURCE COLOR SPACE TO RGBW TARGET COLOR SPACE”, filed Oct. 21, 2003; (3) United States Patent Publication No. 2005/0083352 (“the '352 application”) having application Ser. No. 10/691,396 and entitled “METHOD AND APPARATUS FOR CONVERTING FROM A SOURCE COLOR SPACE TO A TARGET COLOR SPACE”, filed Oct. 21, 2003; and (4) United States Patent Publication No. 2005/0083344 (“the '344 application”) having application Ser. No. 10/690,716 and entitled “GAMUT CONVERSION SYSTEM AND METHODS” filed Oct. 21, 2003. Each of the aforementioned '341, '352 and '344 applications and the '219 patent is hereby incorporated by reference herein in its entirety.

Additional advantages have been described in (1) United States Patent Publication No. 2005/0099540 (“the '540 application”) having application Ser. No. 10/696,235 and entitled “DISPLAY SYSTEM HAVING IMPROVED MULTIPLE MODES FOR DISPLAYING IMAGE DATA FROM MULTIPLE INPUT SOURCE FORMATS”, filed Oct. 28, 2003; and in (2) United States Patent Publication No. 2005/0088385 (“the '385 application”) having application Ser. No. 10/696,026 and entitled “SYSTEM AND METHOD FOR PERFORMING IMAGE RECONSTRUCTION AND SUBPIXEL RENDERING TO EFFECT SCALING FOR MULTI-MODE DISPLAY” filed Oct. 28, 2003, each of which is hereby incorporated herein by reference in its entirety.

Additionally, each of these co-owned and co-pending applications is herein incorporated by reference in its entirety: (1) United States Patent Publication No. 2005/0225548 (“the '548 application”) having application Ser. No. 10/821,387 and entitled “SYSTEM AND METHOD FOR IMPROVING SUB-PIXEL RENDERING OF IMAGE DATA IN NON-STRIPED DISPLAY SYSTEMS”; (2) United States Patent Publication No. 2005/0225561 (“the '561 application”) having application Ser. No. 10/821,386 and entitled “SYSTEMS AND METHODS FOR SELECTING A WHITE POINT FOR IMAGE DISPLAYS”; (3) United States Patent Publication No. 2005/0225574 (“the '574 application”) and United States Patent Publication No. 2005/0225575 (“the '575 application”) having application Ser. Nos. 10/821,353 and 10/961,506 respectively, and both entitled “NOVEL SUBPIXEL LAYOUTS AND ARRANGEMENTS FOR HIGH BRIGHTNESS DISPLAYS”; (4) United States Patent Publication No. 2005/0225562 (“the '562 application”) having application Ser. No. 10/821,306 and entitled “SYSTEMS AND METHODS FOR IMPROVED GAMUT MAPPING FROM ONE IMAGE DATA SET TO ANOTHER”; (5) United States Patent Publication No. 2005/0225563 (“the '563 application”) having application Ser. No. 10/821,388 and entitled “IMPROVED SUBPIXEL RENDERING FILTERS FOR HIGH BRIGHTNESS SUBPIXEL LAYOUTS”; and (6) United States Patent Publication No. 2005/0276502 (“the '502 application”) having application Ser. No. 10/866,447 and entitled “INCREASING GAMMA ACCURACY IN QUANTIZED DISPLAY SYSTEMS.”

### DISCLOSURE OF THE INVENTION

In one embodiment, a display system is disclosed, said display system comprising a display, said display further comprising a plurality of logical pixels wherein said logical pixels further comprise a first number of center-subpixels; a memory, said memory storing said image data to be rendered by said display; wherein said memory is mapped such that said center-subpixels are stored in addressable memory cells.

In another embodiment, a display system is disclosed, said display system comprising a display capable of rendering both a first resolution data set and a second resolution data set, said display system capable of inputting RGB stripe color data and capable of outputting subpixel rendered image data onto said display; said display system further comprising: a first processing unit for said first resolution data set; a second processing unit for processing said second resolution data set; wherein said image data from said first processing unit and said second processing unit is multiplexed to output to said display according to a sync signal.

### BRIEF DESCRIPTION OF THE DRAWINGS

The accompanying drawings, which are incorporated in, and constitute a part of this specification illustrate exemplary implementations and embodiments of the invention and, together with the description, serve to explain principles of the invention.

FIG. 1 shows a conventional display system employing RGB stripe layouts.

FIG. 2 shows a display panel having the conventional RGB stripe repeating subpixel grouping.

FIG. 3 shows a conventional memory structure for a RGB stripe display system.

FIGS. 4-5 show exemplary subpixel layouts, with 6 and 8 subpixel repeating groups respectively, and how certain subpixels may be used to create logical subpixels.

FIGS. 6-7 depict how the notions of odd numbered and even numbered subpixel repeating groups, respectively, may be generalized in how they constitute logical pixels.

FIG. 8 depicts two separate read-modify-write cycles that may be utilized depending upon where the 2 center-subpixels are.

FIGS. 9-10 depict two exemplary display systems depending on whether they have an odd or even subpixel repeating group respectively.

FIGS. 11-12 depicts the displays of the display systems as seen in FIGS. 9-10.

FIGS. 13-14 depicts an exemplary embodiment of a memory map for the displays and systems of odd and even subpixel repeating group respectively.

FIGS. 15-16 depicts an exemplary embodiment of a timing diagram for the displays and systems of odd and even subpixel repeating group respectively.

FIGS. 17-18 depicts two embodiments of timing diagrams for specific displays having specific subpixel repeating.

FIG. 19 shows an exemplary basic architecture of a RGBW display system with a frame buffer.

FIG. 20 shows an alternative basic architecture of a RGBW display system without a frame buffer.

FIG. 21 depicts one embodiment of an improved architecture that may support VGA image rendering.

FIG. 22 depicts an alternate data path if VGA data is available for rendering.

FIG. 23 depicts one embodiment that supports both qVGA and VGA rendering schematically.

FIG. 24 shows one possible range of output gamma values.

FIG. 25 shows the possible differences in output gamma values.

### DETAILED DESCRIPTION

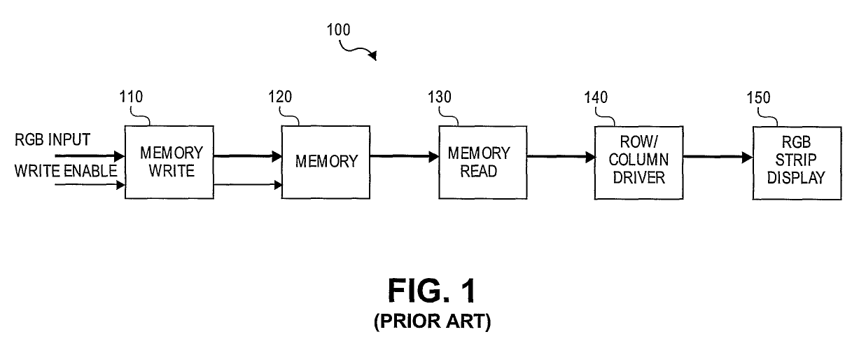

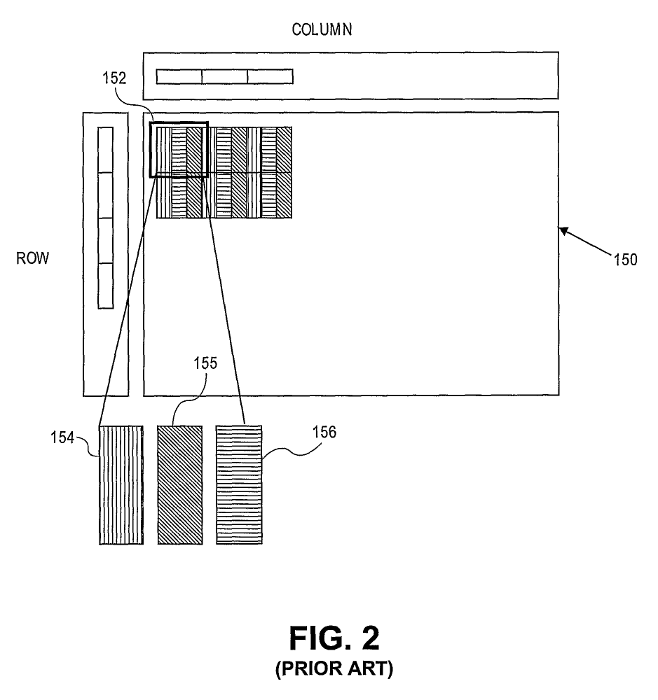

The traditional RGB stripe system As shown in FIG. 1, a conventional RGB-Stripe display system (100) consists of Memory write (110), Memory (120), Memory read (130), Row/Column Driver (140) and RGB-Stripe Display (150). Input RGB data is stored into Memory (120) through Memory Write (110) controller based on write enable signal. Stored RGB data are displayed on the RGB-Stripe Display (150) through Memory Read (130) controller and Row/Column Driver (140). As shown in FIG. 2, RGB-Stripe Display (150) consists of horizontally and vertically repeated subpixel array (152) based on red (154), green (155) and blue (156) one. This conventional type of repeated subpixel array is called a “physical” pixel.

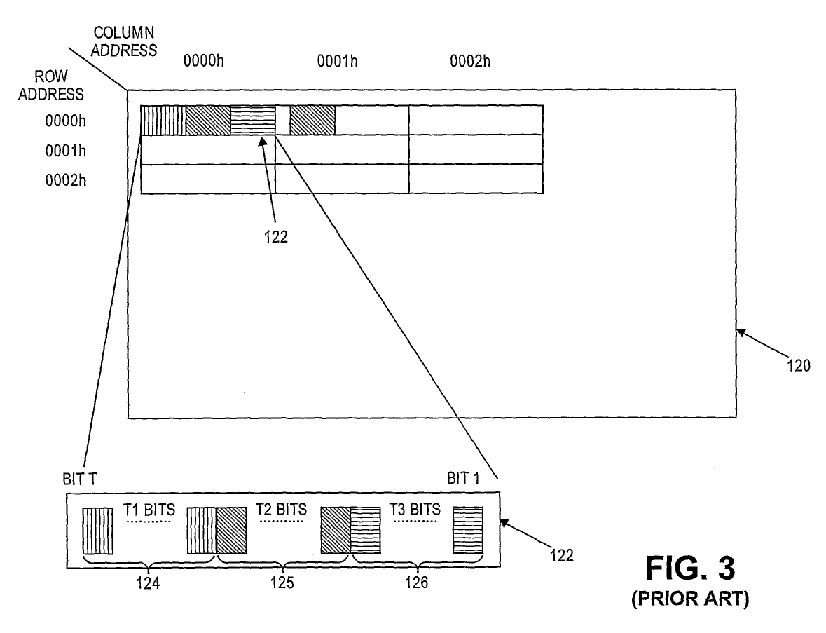

As shown in FIG. 3, the conventional memory structure (120) also shows a multiple of three-subpixel array (122) including red subpixel data (124), green subpixel data (125) and blue subpixel data (126). Each subpixel data typically has T1, T2 and T3 bit depths and total bit depth of a pixel is T=T1+T2+T3. Since this memory scheme is based on physical pixels, this memory architecture is exactly one to one mapped into RGB stripe display. It means that one memory write cycle is needed to update one physical pixel.

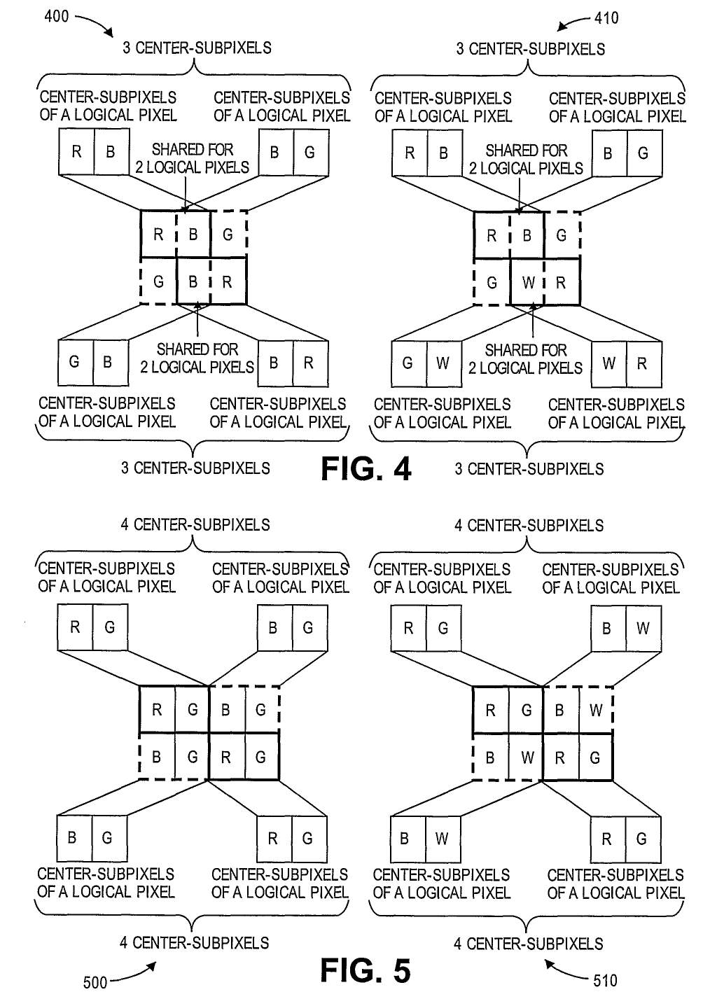

Generally speaking, several sub-pixels are combined to display one color dot called as pixel. For legacy RGB stripe display as noted above, one physical pixel typically consists of three colored subpixels—red, green and blue. However, for certain displays having novel subpixel architectures (as noted in many of the applications herein incorporated by reference), other logical groupings of colored subpixels are possible to provide a potentially multi-colored spot. For example, one or two center-subpixels and some adjacent ones may be combined into one pixel through a subpixel rendering algorithm, which is still serves as one potentially multi-color dot. Such an arrangement is called a “logical” pixel. “Center-subpixels” may be physically in the center of a logical pixel and may also be the brightest portion in a logical pixel. FIG. 4-7 show the examples of center-subpixels. Such logical subpixel groupings may be various spatial groupings of actual colored subpixels wherein each such colored subpixel holds its data values over time. Other logical subpixel groupings may employ a subpixel sharing on a temporal basis whereby actual subpixels change their data values frame-by-frame to create an impression to the human eye of a single multi-colored spot. Such temporally-based logical pixels are discussed further references like U.S. Pat. No. 6,661,429 to Phan.

To express one pixel, the logical pixel approach typically needs more subpixels than a physical one; however, its total number of subpixel on screen could be reduced because all adjacent subpixels are shared by the other pixels. The number of center-subpixel in a logical pixel may also be smaller than the number of subpixel in a physical pixel. It is noted that the colors of center-subpixel may vary according to the position; however, an array of center-subpixels is usually repeated.

In one embodiment of a system made in accordance with the principles of the present application, center-subpixels and some adjacent subpixels are combined to form a logical pixel. For the variety of novel subpixel layouts that are disclosed in the patent applications incorporated by reference, there are two broad categories of layouts: (1) subpixel layouts comprising an odd number of center-subpixels for two logical pixels and (2) subpixel layouts comprising an even number of center-subpixels for two logical pixels.

As an example of the first category of subpixel layouts, FIG. 4 shows two subpixel layouts 400 and 410, each having an odd number of center-subpixels. Both subpixel layouts 400 and 410 comprise a 6-subpixel repeating array—wherein the red and the green subpixels are on a checkerboard pattern and layout 400 further comprises two blue subpixels—whereas layout 410 further comprises a blue and a white subpixel. Both layouts 400 and 410 comprise three center-subpixels to display two logical pixels, as shown in FIG. 4.

As an example of the second category of subpixel layouts, FIG. 5 shows two subpixel layouts 500 and 510, each having an even number of center-subpixels. Both subpixel layouts 500 and 510 comprise an 8-subpixel repeating array. Layout 500 shows that the green subpixels are interspersed with red and blue subpixels that are on a checkerboard pattern. Layout 510 shows that the red and blue subpixels form a first checkerboard pattern, whereas the green and white subpixels form a second checkerboard pattern. Both layouts 500 and 510 comprise four center-subpixels to display two logical pixels, as shown in FIG. 5.

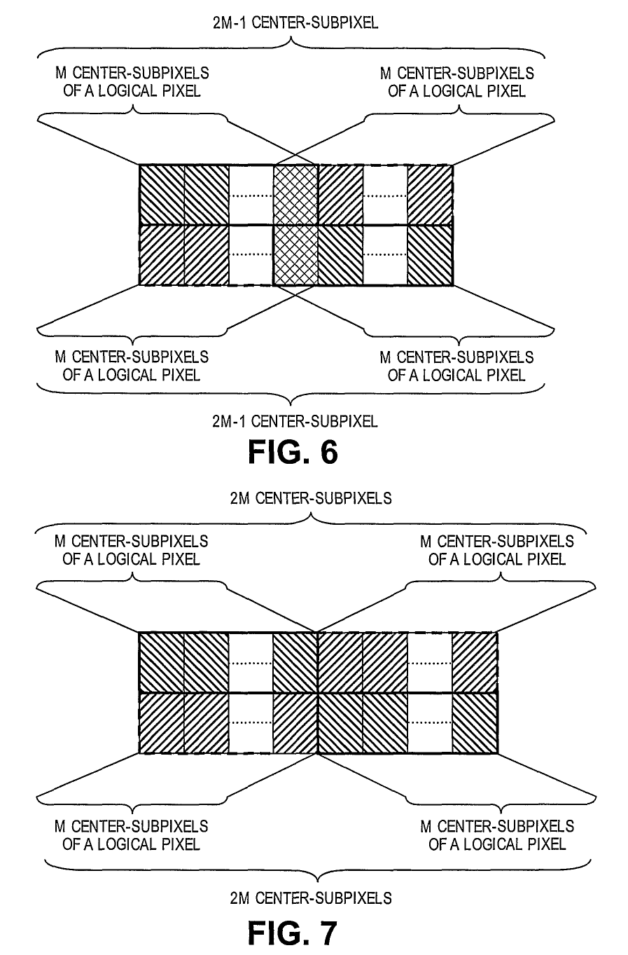

It should be appreciated that the layouts depicted in FIG. 4 and 5 are merely exemplary and that many other layouts (as incorporated by reference from the above-identified patent applications) suffice and are contemplated by the present invention. In addition, it should be appreciated that the principles of the present invention generalize to any “odd number” layouts comprising 2M-1 center-subpixels for 2 logical pixels and each logical pixel needs M subpixels as shown in FIG. 6. Further, the principles of the present invention generalize to any “even number” layouts comprising 2M center-subpixels for 2 logical pixels and each logical pixel needs M subpixels as shown in FIG. 7.

In one embodiment, such a display system comprising a subpixel layout that is different from the traditional RGB stripe layout may need to accept legacy RGB stripe image data. In such a case, there is a notion of how many center-subpixels are updated for one RGB stripe input pixel for such a system. In the case of an “odd number” display system (e.g. as shown in FIG. 4), it is possible that 1.5 center-subpixels are updated for every RGB input pixel—or, alternatively, 3 center-subpixels should be practically updated for two RGB input pixels. In the case of an “even number” display system, (e.g. as shown in FIG. 5), it is possible that 2 center-subpixels are updated for one RGB input pixel. In general, for odd number systems, 2M-1 center-subpixels may be updated for two RGB input pixels and for even number systems, M subpixels should be updated for one RGB input pixel.

Memory Structures for Novel Systems

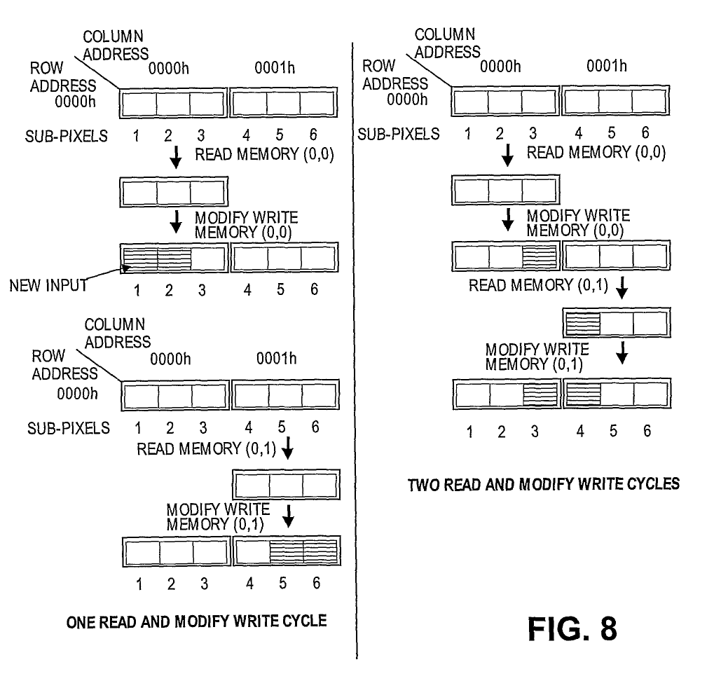

For these novel systems, it may be desirable to design memory structures that are typical for RGB stripe systems. For example, if an even number system were to use conventional memory structures bases on the three subpixel repeating group as shown in FIG. 3, Memory Write block (110) might need more steps to get each sub-pixel aligned to the legacy memory structure. For example, FIG. 8 depicts that different read-modify-write cycles may be needed, depending on where 2 center-subpixels are.

Thus, it may be possible and desirable to design two kinds of memory structure based on even and odd number display systems. These memories could be updated based on how many center-subpixels of each display are needed. For example, for odd number displays, 2M-1 center-subpixels for two logical pixels may be updated with one memory-write cycle. For even number displays, M center-subpixels for one logical pixel may also be updated with one memory-write cycle.

One benefit of the above novel display systems might be a reduction in the number of output Gamma Look-Up Tables (LUTs). For example, most conventional display system uses one output gamma LUT per each color. Since three colors are processed in parallel and also displayed together, there typically is three output gamma LUTs. However, in the case of the odd and even number display systems disclosed herein, since they output M or 2M-1 center-subpixels with one memory-write cycle, M or 2M-1 output gamma LUTs might suffice depending upon subpixel layout. For example, for even number displays, the number of center-subpixels, M, is smaller than the number of subpixel per physical pixel. In case of layouts of FIG. 5 above, M is equal to 2. Thus, assuming that all subpixel colors need a same or similar output gamma curve, two output gamma LUTs suffice only during one memory-write cycle.

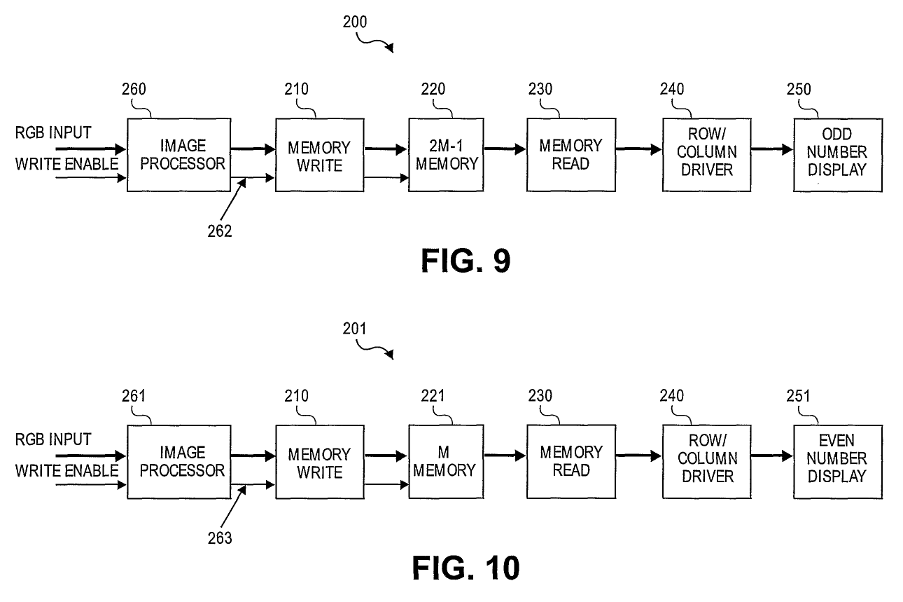

As shown in FIG. 9, one example of an odd number display system (200) is shown. System 200 comprises memory write (210), 2M-1 memory (220), memory read (230), row/column driver (240), odd number display (250) and image processor (260). After image processor (260) receives two input RGB pixels and two write enable signals, it may generate 2M-1 center-subpixels with one write enable (262) which are stored into 2M-1 memory (220) through memory write (210). These rendered data are displayed on odd number display (250) through memory read (230) and row/column driver (240).

As shown in FIG. 10, one example of an even number display system (201) is shown. System 201 comprises memory write (210), M memory (221), memory read (230), row/column driver (240), even number display (251) and image processor (261). After image processor (261) receives one input RGB pixel and one write enable, it may generate M center-subpixels with one write enable (263) which are stored into the M memory (221) through memory write (210). These rendered data are displayed on even number display (251) through memory read (230) and row/column driver (240).

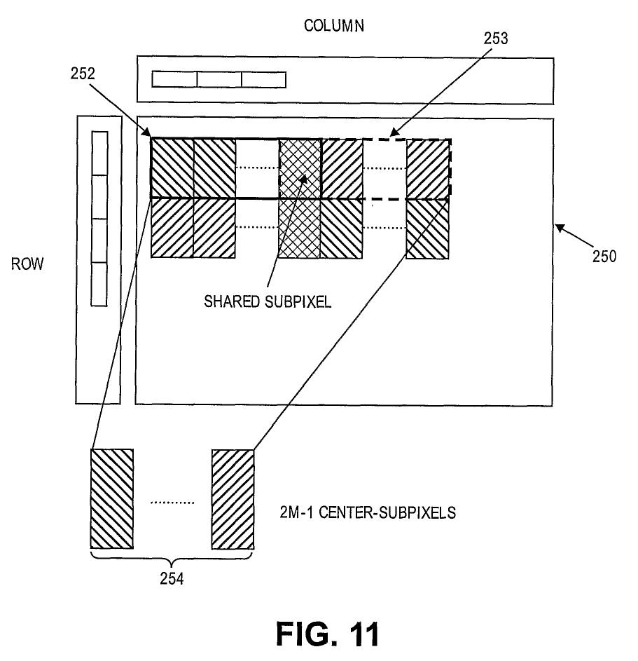

Embodiments of an odd number display and an even number display are shown in FIGS. 11 and 12 respectively. In odd number display 250, one center-subpixel may be shared by two adjacent logical pixels (252, 253). 2M-1 center-subpixels (254) are displayed for two logical pixels, which are from 2M-1 memory. In even number display 251, as no center-subpixel is shared by two adjacent logical pixels (256, 257), M center-subpixels (258) are displayed for one logical pixels, which are from M memory.

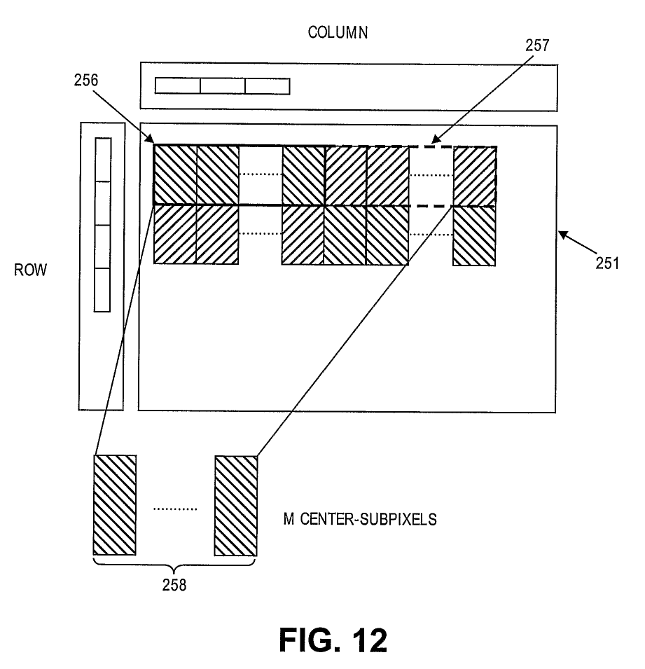

FIGS. 13 and 14 are two embodiments of memory maps for odd number and even number systems respectively. In odd number memory map 220, 2M-1 center-subpixels for two logical pixels may be stored into one addressed first memory cell (222) with one write cycle. Next 2M-1 center-subpixels for next two logical pixels may be stored into one addressed second memory cell (223) with next one write cycle. Each center-subpixel data has a different bit-depth (N1 bits, N2 bits . . . N(2M-1) bits). First center-subpixel (224) has Ni bit-depth and 2M-1^{th} center subpixel (225) has N(2M-1) bit-depth. In even number memory map 221, M center-subpixels for one logical pixel may be stored into one addressed first memory cell (226) with one write cycle. Next M center-subpixels for next one logical pixel may be stored into one addressed second memory cell (227) with next one write cycle. Each center-subpixel data may have a different bit-depth (K1 bits, K2 bits . . . K(M) bits). First center-subpixel (228) has K1 bit-depth and M^{th} center subpixel (229) has KM bit-depth.

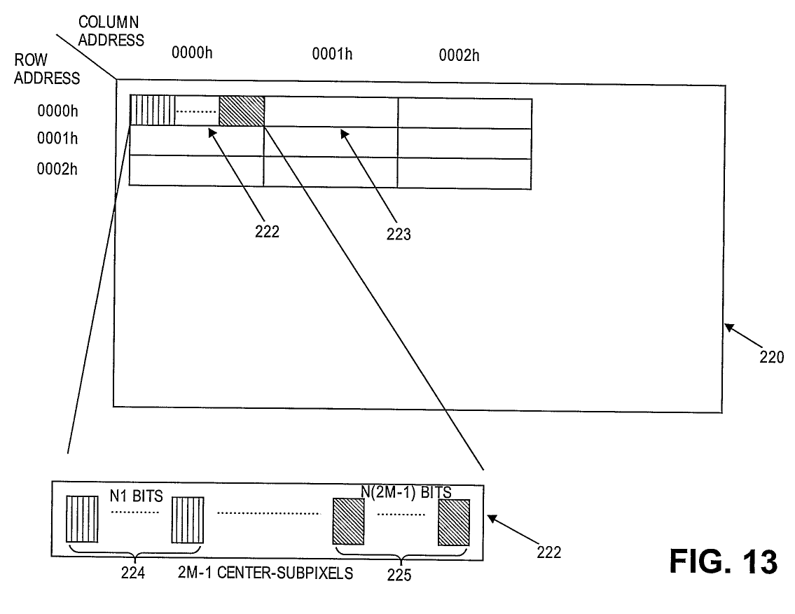

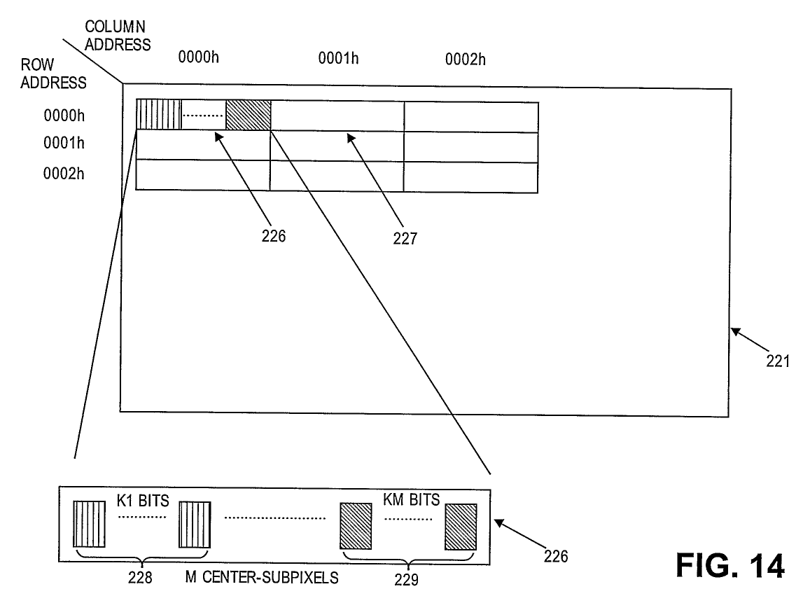

FIGS. 15 and 16 show embodiments of general timing diagrams of odd and even number processors respectively. In particular, FIG. 17 shows the timing diagram for a display system comprising panel 400 shown FIG. 4. Thus, based on two RGB input pixels and two write enables, three center-subpixels may be output with one write enable. Also in particular, FIG. 18 shows the timing diagram of a display system comprising panel 510 in FIG. 5. Thus, with two RGB input pixels and two write enables, it may output four center-subpixels with two write enables, which means two center-subpixels per each write enable.

Memory Support for VGA Rendering

VGA operation requires a large frame buffer ( for example, 3.7 MBit) which adds excess cost and size to driver ICs, particularly for cell phone and other small portable display systems. If the frame buffer is eliminated, the bandwidth to the panel for synchronous operation is high (˜20 MHz), which can cause EMI problems. Thus, a novel VGA architecture is disclosed herein that applies to a wide variety of portable display systems.

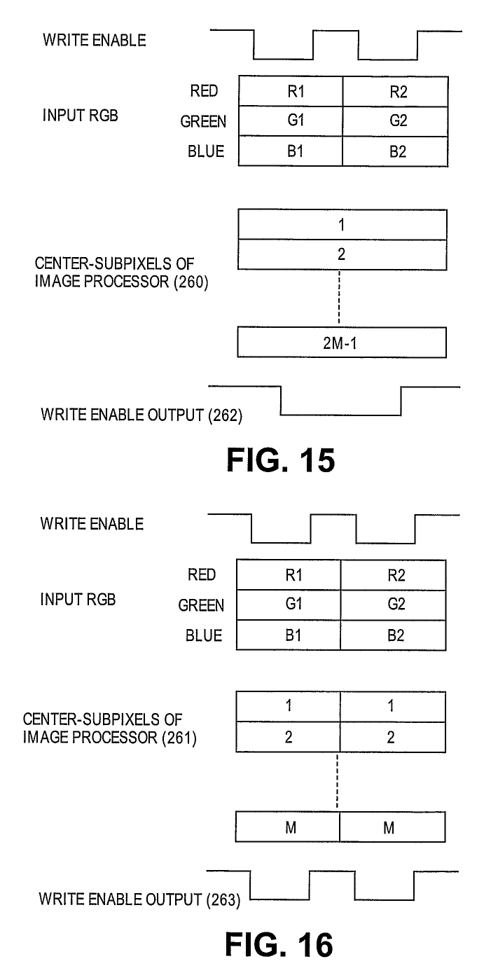

FIG. 19 shows the basic architecture 1900 of driver IC with integrated frame buffer 1914 and driver IC. System 1900 might comprises several (optional) subsystems—e.g. input gamma LUT 1902, programming registers 1904, white pixel processing (or alternatively, a GMA for multiprimary display systems) 1906, subpixel processing unit 1910, output gamma LUT 1912, refresh buffer 1914, source driver 1916. Output of refresh buffer could be clocked out a line at a time to the line buffer preceding the source driver D/As. This architecture provides compatibility with both MPU and RGB input since the data can be stored in the refresh buffer. One concern with this approach is mainly the memory speed (which would support VGA bandwidths) and cost.

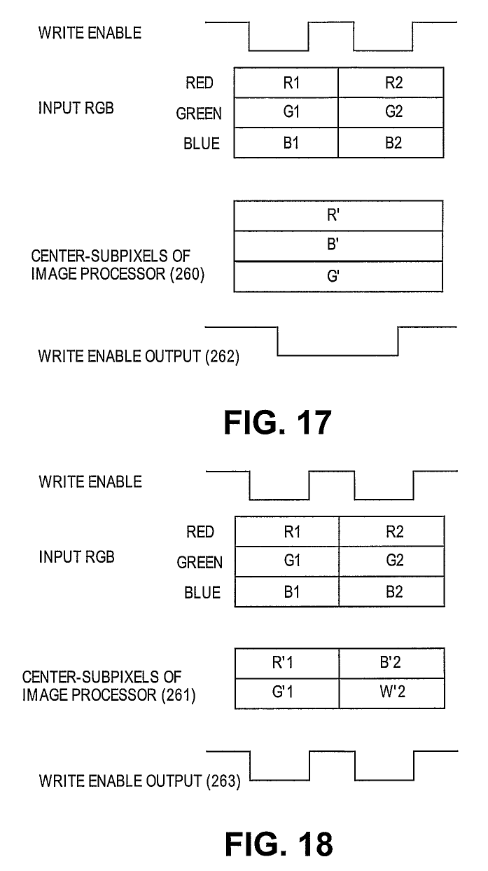

An alternative architecture is shown in FIG. 20, where the frame buffer is eliminated. System 2000 might comprises several (optional) subsystems—e.g. input gamma LUT 2002, programming registers 2004, white pixel processing (or alternatively, a GMA for multiprimary display systems) 2006, subpixel processing unit 2010, output gamma LUT 2012, serial to parallel line buffer 2014, source driver 2016. In one embodiment, the data could be synchronous and operate at 60 Hz refresh to prevent flicker. In addition, the data rate might run at approximately 20 MHz. However, even this system may result in EMI problems and may use more power.

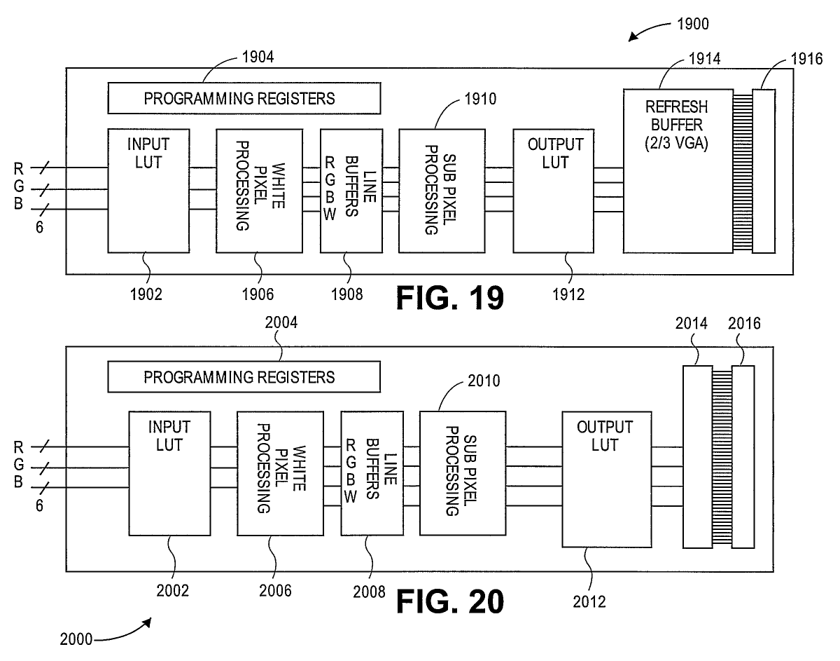

FIG. 21 shows a new architecture 2100 for supporting asynchronous data flow in a qVGA mode of operation which may be used as a dual qVGA/VGA display system. System 2100 may comprise input gamma processing 2102, gamma mapping algorithm unit (GMA) and inverse gamma processing 2104, 960×320 frame buffer which is bifurcated as storage 2106 and 2108, line buffers 2110 and drivers 2112.

Memory 2106, 2108 may comprise 12 bit architecture with RG data in upper memory and BW data in lower memory. It will be appreciated that other architectures will also work—e.g. 18 bit. In this mode of operation, white pixel processing may be performed by the image processor. RG and BW swapping may be also done to support rotation modes of the display. Thus, it is possible to achieve compatibility with existing qVGA data with system 2100.

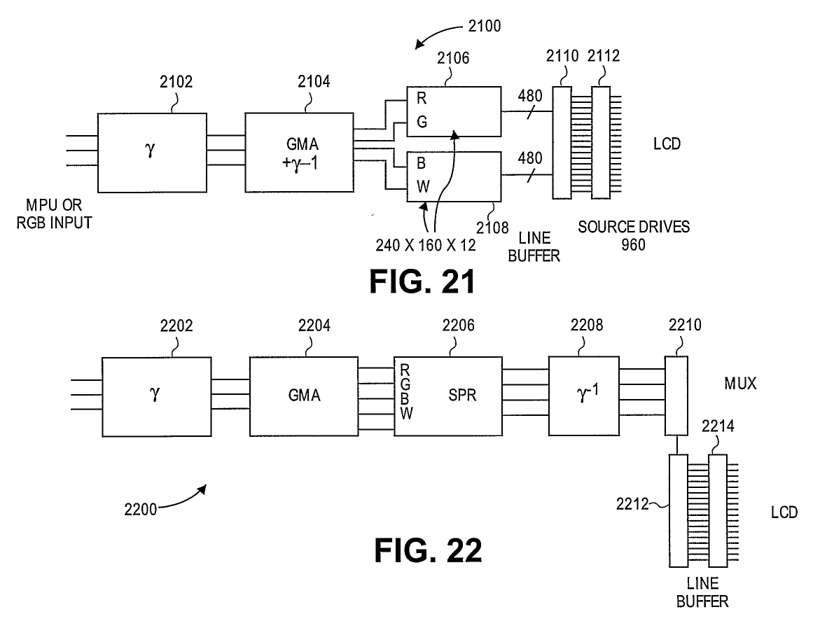

If VGA data is available, a different data path may be used, as illustrated in FIG. 22. System 2200 may comprise input gamma 2202, GMA 2204, subpixel rendering 2206, inverse gamma 2208, mux 2210, line buffer 2212, and drivers 2214. In this path, data from RGB source may be processed through gamma pipeline, GMA, and SPR. At output, data may be multiplexed into correct RGBW order for output to display. Data in this example could be synchronous at refresh rate that is necessary for LCD operation, e.g. 60 Hz.

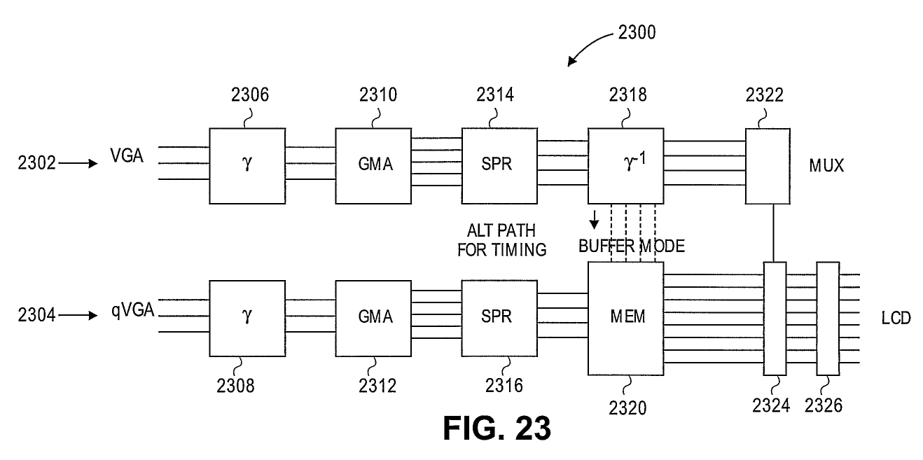

To support both VGA and qVGA data, the two data paths 2302 and 2304 are combined. This is shown schematically in FIG. 23. System 2300 may comprise input gamma 2306 and 2308, GMA 2310 and 2312, SPR 2314 and 2316, inverse gamma 2318, memory 2320, mux 2322, line buffer 2324, and drivers 2326. Async or sync data at qVGA timing may be written to memory in the normal way. Sync data from VGA data path may flow to line buffer just before source drivers. VGA data may be full screen or just a window within the 480×640 display. In window mode, the data may be combined with qVGA data at the final line buffer.

It should be noted that while two input gamma and GMA block are shown, they can actually be multiplexed so that only one set of gates are required. It should also be noted that the memory read timing may follow the VGA sync signal. In qVGA mode, a PLL may generate the LCD output timing.

Efficient Gamma Table Implementations

In at least one embodiment of a display system, gamma tables are used to support “gamma pipeline”. To implement gamma pipeline, a RAM table may be employed. Such an approach may work well; but there may be other considerations for such a system—e.g. 1) loading time may be long, especially for mobile phone, 2) ASIC size is increased. It may be desirable to use ROM table, but the system possibly loses the capability to adjust the gamma values.

In one embodiment of a display system made in accordance with the principles of the present invention, it is possible to employ a two stage system and method to adjust gamma for both input and output gamma which is ROM based and programmed with a few registers.

Conventional output gamma, particularly for mobile phone and other display systems, it is typical to use 10 bits for processing and 6 bits output. Thus a 10 to 6 bit table is employed, which uses 1024*6/8=768 bytes of memory for each color. Thus, for a three-color system (e.g. RGB) there are three such tables; while for four color system (e.g. RGBW), there may be four tables.

The following discussion will describe one possible embodiment and particularly for the treatment of one color. It will be appreciated that other colors may be treated similarly. One embodiment may adjust gamma within a pre-determined amount (e.g. +/−0.5 for merely one example) around the desired value of inverse gamma (e.g. 1/2.2 for merely one example)—possibly by some increment (e.g. 0.1 or some other value that may be pre-determined or dynamically generated). In this embodiment, it is possible to store a gamma (e.g. 1/2.2 for merely one example) as 10 bit address and 6 bit entries (or M bit address and N bit entries where M=>N in general).

For most LCDs, it will be sufficient to use this default table. However, if gamma needs to be adjusted, it is possible to add extra smaller correction LUT ROM tables that contain the “difference” between multiple gamma values (e.g. between, for example, 1/2.2 and 1/2.0). A first step in data processing might be to look up the 6 bit value corresponding to the 10 bit input. Then the 6-bit output value may be used as the address for a second LUT to look up the correction value. The two outputs are added and output to the display.

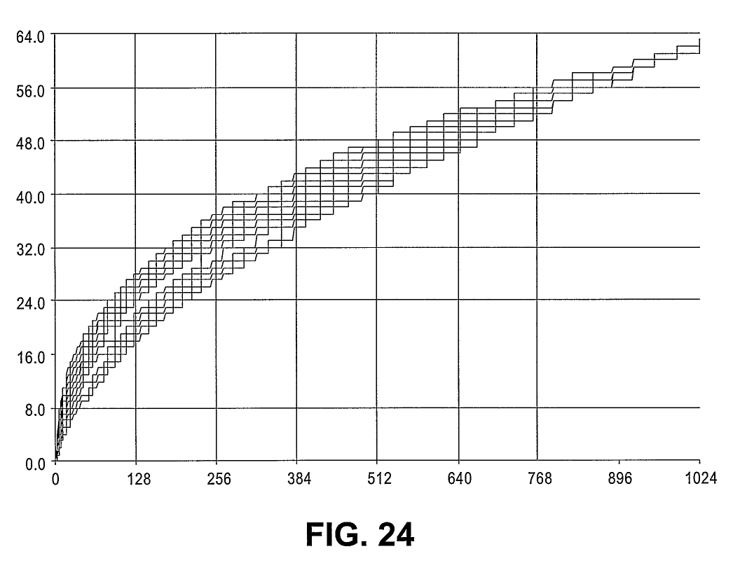

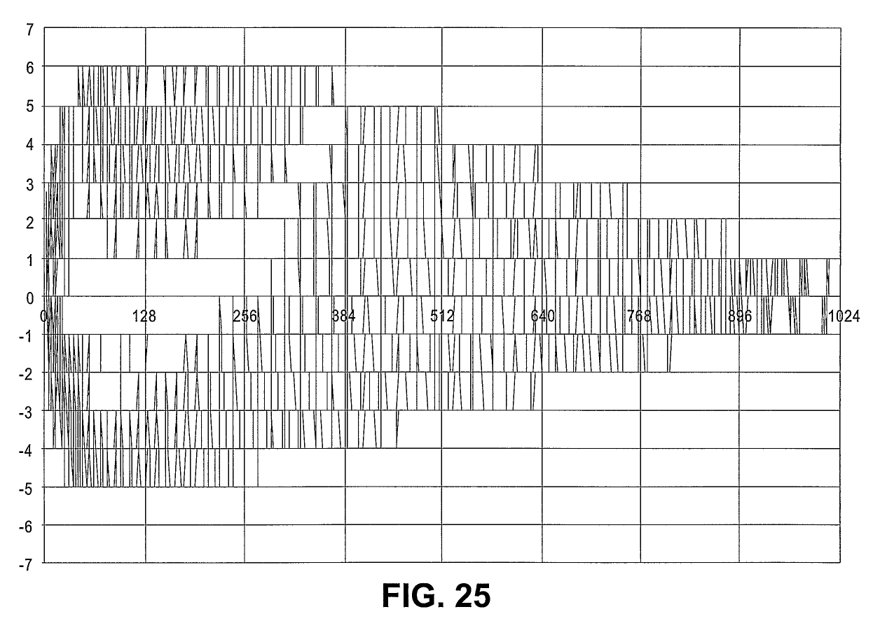

For merely one example, the range of output gamma from 1.7 to 2.7 in steps of 0.1 is shown in FIG. 24 (e.g. 10 bit to 6 bit). As can be observed, the difference in out put values may not be large. In fact, the difference from 1/2.2 gamma may be represented with a 3 bit number, as may be seen in FIG. 25 which shows the difference in gamma table value between a reference gamma of 1/2.2 and gamma values from 1/1.7 to 1/2.7.; the maximum difference is less than 8. Thus, the correction ROMs are 64*3/8=24 bytes each. For 10 tables, it may be possible to us 768+240=1008 bytes for each color instead of 7680 bytes for 10 separate tables. It may also be possible to add a 4 bit register to choose the output table for each of four colors (e.g. a RGBW system). Thus, two (2) 8 bit registers may be sufficient to achieve a gamma range from 1.7 to 2.7 for output gamma using the combined LUTs.

In another embodiment, the calculated error in this process compared to fixed ROM tables may be less than 0.5 out of 63. If this error becomes visible in gray wedges, a dithering method may be used to reduce the error. This can be easily accomplished by switching between two ROM correction LUTs at frame rate. Flicker should be negligible since the change in luminance is small.

For input gamma, it may suffice to use one gamma table, e.g. sRGB, for each color RGB. This is, for one example, a 6 bit address with 10 bit outputs (e.g. 80 bytes×3 =240 bytes). However, if adjustments are needed to input gamma, the same strategy can be employed as described for output gamma. In this case, a secondary table may use more bits because of the 10 bit output. For merely one example, for +/−0.5 input, the error from 2.2 gamma may have a max of approximately 96—so a 7 bit LUT output may be added to the 2.2 value. Since the purpose of input gamma is to match to human eye, it is possible that only one or two extra gamma choices may suffice e.g. 2.0, 2.2, 2.4. For this limited set, the max value of error may be reduced—e.g. approximately 36, so a 6 bit table may be sufficient. Thus, in one embodiment, the size of the correction LUT may therefore be 64*6=48 bytes for each table for each color. For merely one example if two tables are used, the total ROM size may be 64*10/8=80 bytes for main use, plus 96 bytes for two extra tables, for a total of 176 bytes/color.

In comparison with a conventional system, to achieve fully programmable gamma tables for 6-6-6 input, 10 bit internal processing, and RGBW output, a conventional system may comprise: 240 bytes input SRAM and 3072 bytes output SRAM. Alternatively, for a conventional system using ROM tables, it may require 1920×3=720 bytes input ROM (three choices for each RGB) and 34K bytes for 11 choices of output ROM (RGBW).

By comparison, an embodiment of the present application may suffice with a total input ROM of 240 bytes for sRGB ROM, 528 bytes for secondary input LUTs. So, for the primary LUT, it would suffice to have 768*4=3072 bytes, plus 960 bytes for secondary LUT for RGBW. Complete programming can be accomplished with three 8 bit registers. For other embodiments, if the number of bits is changed for input and output, it would be easy to calculate the memory savings.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A display system comprising:
a display, said display comprising a plurality of logical pixels wherein said logical pixels further comprise a first number of center-subpixels;
a memory, said memory storing said image data to be rendered by said display; wherein said memory is mapped such that said center-subpixels are stored in addressable memory cells.

2. The display system of claim 1 wherein said number of center-subpixels for each logical pixel is an odd number.

3. The display system of claim 1 wherein said number of center-subpixels for each logical pixel is an even number.

4. The display system of claim 2 wherein at least two logical pixels share at least on subpixel among a plurality of center-subpixels.

5. The display of claim 2 wherein 2M-1 center subpixels for two logical pixels are stored in one addressable memory cell.

6. The display of claim 3 wherein M center-subpixels for one logical pixel is stored in one addressable memory cell.

7. In a display system, said display system comprising a display capable of rendering both a first resolution data set and a second resolution data set, said display system capable of inputting RGB stripe color data and capable of outputting subpixel rendered image data onto said display; said display system further comprising:
a first processing unit for said first resolution data set;
a second processing unit for processing said second resolution data set;
wherein said image data from said first processing unit and said second processing unit is multiplexed to output to said display according to a sync signal.

8. The display system of claim 7 wherein said first resolution data set is qVGA data and said second resolution data set is VGA data set.

9. The display system of claim 8 wherein said output image data is converted to RGBW image data.

10. The display system of claim 10 wherein said first processing unit further comprises at least two memories for storing a first set of color image data and a second set of color image data.

11. The display system of claim 11 wherein said first set of color image data is red and green color image data and said second set of color image data is blue and white color image data.

12. The display system of claim 7 wherein said display system further comprises a first stage and a second stage gamma table wherein said first stage gamma table encodes values adjusted for a predetermined amount of inverse gamma and further wherein said second stage gamma table encodes values for small corrections to said first stage gamma table values.

13. The display system of claim 12 wherein said second stage gamma values encodes difference values between multiple gamma values.
